(19) United States
(12) Patent Application Publication
(10) Pub. No.: US 2004/0075546 A1
(43) Pub. Date: Apr. 22, 2004

(54) Vehicle light management

(75) Inventor: Menachem Hadar, Yavne (IL)

Correspondence Address: Ladas & Parry, 26 West 61st Street, New York, NY, 10023, US

(73) Assignee: IBS (IMPULSE BREAK SIGNAL) LTD.

(21) Appl. No.: 10/266,673

(22) Filed: Oct. 8, 2002

(51) Int. Cl. B60Q 1/44

(52) U.S. Cl. 340/479; 340/693.4

(57) ABSTRACT

A brake light system for a land motor vehicle including a source of electrical power adapted to be mounted in a land motor vehicle, at least one brake light, a brake light switch connecting the at least one brake light to the source of electrical power and a voltage booster for increasing the voltage of the electric power received from the source of electrical power to a higher voltage which is supplied to the at least one brake light

### FIELD OF THE INVENTION

The present invention relates to land motor vehicles generally and more particularly to brake light systems for land motor vehicles

### BACKGROUND OF THE INVENTION

The following patent publications are believed to represent the current state of the art

Published PCT Patent Application WO 02/28667; and

U.S. Pat. Nos. 4,631,470; 5,760,490; 6,307,330 and 6,332,578.

Published statistics indicate that tailgating accidents occur annually in the USA, involving many fatalities It is known that currently the average minimum time duration between a forward driver pressing on his brakes and a following driver pressing on his brakes is approximately 750 milliseconds, during which time a car traveling at 55 mph travels 60 5 feet The time duration of 750 milliseconds includes approximately 200 milliseconds between the forward driver pressing on his brakes and illumination of the brake lights

### SUMMARY OF THE INVENTION

The present invention seeks to provide improved brake light systems for land motor vehicles.

There is thus provided in accordance with a preferred embodiment of the present invention a brake light system for a land motor vehicle including a source of electrical power adapted to be mounted in a land motor vehicle, at least one brake light, a brake light switch connecting the at least one brake light to the source of electrical power and a voltage booster for increasing the voltage of the electric power received from the source of electrical power to a higher voltage which is supplied to the at least one brake light

Preferably, the voltage booster includes a voltage boosting timing functionality operative to provide voltage boosting by the voltage booster only after occurrence of an inrush current peak in the electrical power which is supplied to the at least one brake light Alternatively or additionally, the voltage booster includes current attenuating functionality operative to attenuate the peak inrush current supplied to the at least one brake light. Additionally or alternatively, the voltage booster is also operative for initially illuminating the at least one brake light to a relatively high level of illumination and thereafter to reduce illumination of the at least one brake light to a relatively low level of illumination

There is also provided in accordance with a preferred embodiment of the present invention a brake light operating method for a land motor vehicle including a source of electrical power, at least one brake light and a brake light switch connecting the at least one brake light to the source of electrical power, the method including increasing the voltage of the electric power received from the source of electrical power to a higher voltage and supplying electrical power at the higher voltage to the at least one brake light

Preferably, the increasing the voltage occurs after occurrence of an inrush current peak in the electrical power supplied to the at least one brake light.

In accordance with another preferred embodiment, the method also includes attenuating the inrush current peak supplied to the at least one brake light

In accordance with yet another preferred embodiment, the method also includes initially illuminating the at least one brake light to a relatively high level of illumination and thereafter reducing illumination of the at least one brake light to a relatively low level of illumination.

### BRIEF DESCRIPTION OF THE DRAWINGS

The present invention will be understood and appreciated more fully from the following detailed description, taken in conjunction with the drawings in which

FIG. 1A is a simplified timing diagram illustrating operation of a brake light system constructed and operative in accordance with a first embodiment of the present invention,

FIG. 1B is a simplified block diagram illustration of circuitry employed in the brake light system whose operation is illustrated in FIG. 1A,

FIG. 1C is a simplified electrical schematic illustration of the circuitry of FIG. 1B,

FIG. 2A is a simplified timing diagram illustrating operation of a brake light system constructed and operative in accordance with a second embodiment of the present invention;

FIG. 2B is a simplified block diagram illustration of circuitry employed in the brake light system whose operation is illustrated in FIG. 2A, and

FIG. 2C is a simplified electrical schematic illustration of the circuitry of FIG. 2B

### DETAILED DESCRIPTION OF PREFERRED EMBODIMENTS

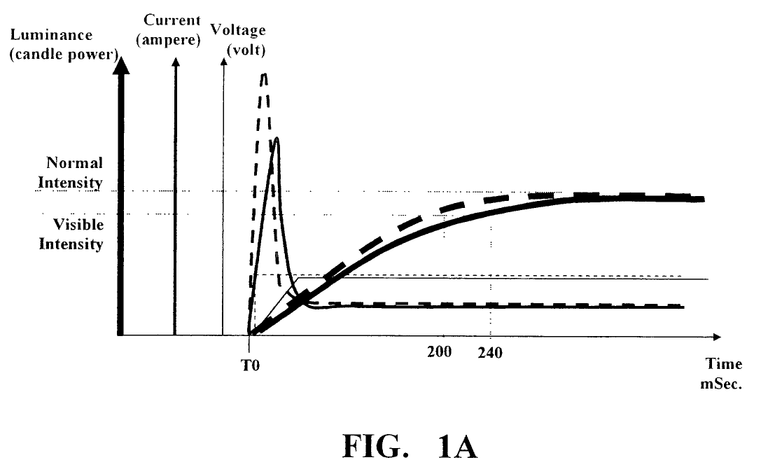

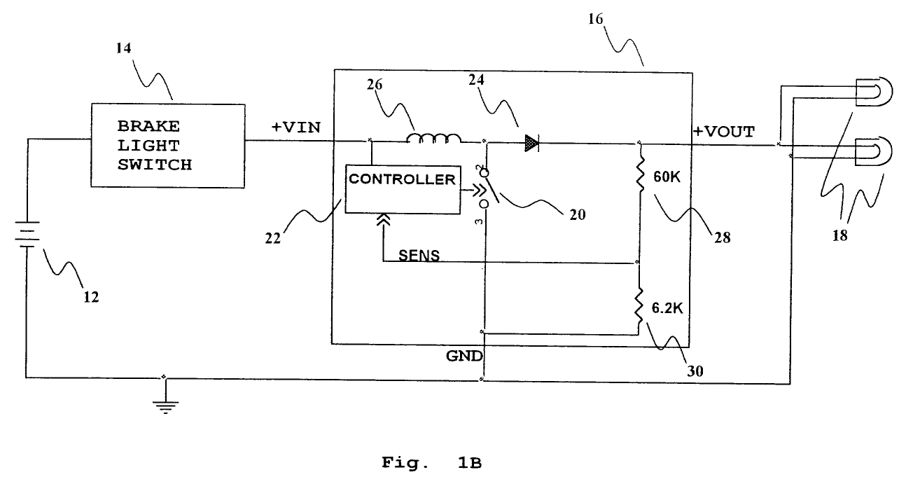

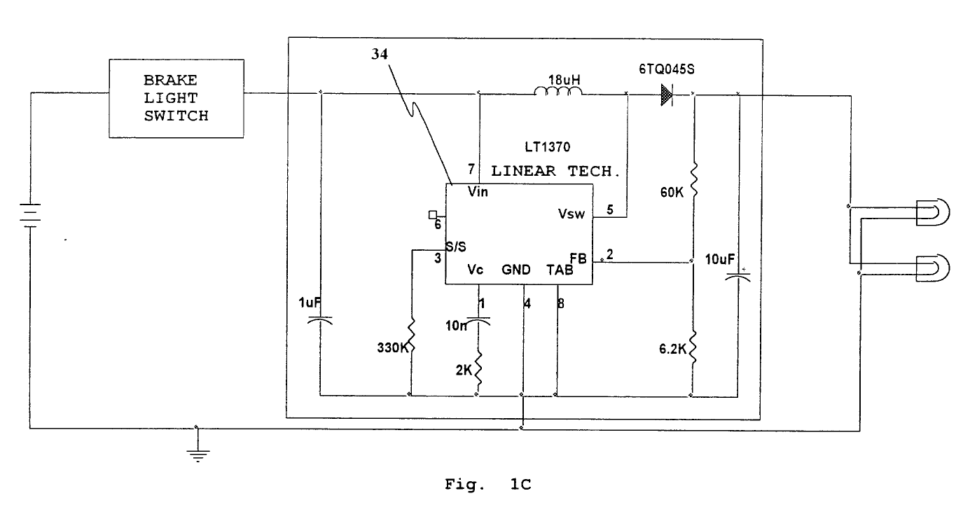

Reference is now made to FIG. 1A, which is a simplified timing diagram illustrating operation of a brake light system constructed and operative in accordance with a first embodiment of the present invention Dashed lines indicate the operation of prior art systems while solid lines indicate the operation of the system of the present invention Plots of luminance, current and voltage appear and are distinguished by their line thickness

As seen in FIG. 1A, typically, in the prior art it takes about 200 msec from actuation of a brake light switch for a brake light to become sufficiently illuminated so as to be noticed by a following driver.

The embodiment of FIG. 1A slightly increases the time of illumination of a brake light from about 200 msecs to about 240 msecs, which is not particularly desirable but substantially decreases the inrush current supplied to the brake lights, typically by one-third thus greatly increasing brake light life time, typically by a factor of approximately 1 5, which is highly desirable.

This substantial and significant increase in the lifetime of the brake lights is provided, in accordance with a preferred embodiment of the present invention, by ramping the voltage applied to the brake light, preferably beginning upon initial illumination of the brake light

Reference is now made to FIG. 1B, which is a simplified block diagram illustration of circuitry employed in the brake light system whose operation is illustrated In FIG. 1A As seen in FIG. 1B, a series connection is defined between a vehicle battery 12, a brake light switch 14 coupled to a brake lever of a vehicle, a current control circuit 16 and brake lights 18 The current control circuit 16 preferably comprises an electronic switch 20, the operation of which is governed by a controller 22 Electronic switch 20 governs a switching power supply including a diode 24 and an inductor 26. A pair of series connected resistors 28 and 30, preferably having the values indicated in FIG. 1B, is provided between the voltage output of diode 24 and ground. The voltage at the junction between resistors 28 and 30 is fed back to controller 22 to enable controller 22 to control the output voltage supplied to the brake lights 18

FIG. 1C is a simplified, self-explanatory, electrical schematic illustration of the circuitry of FIG. 1B It is noted that the electronic switch 20 and the controller 22 are both principally embodied in a single integrated circuit 34, preferably a Linear Technologies LT1370

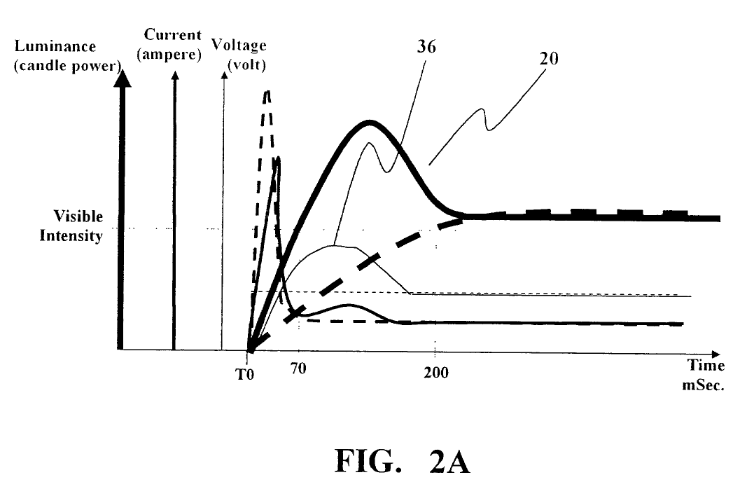

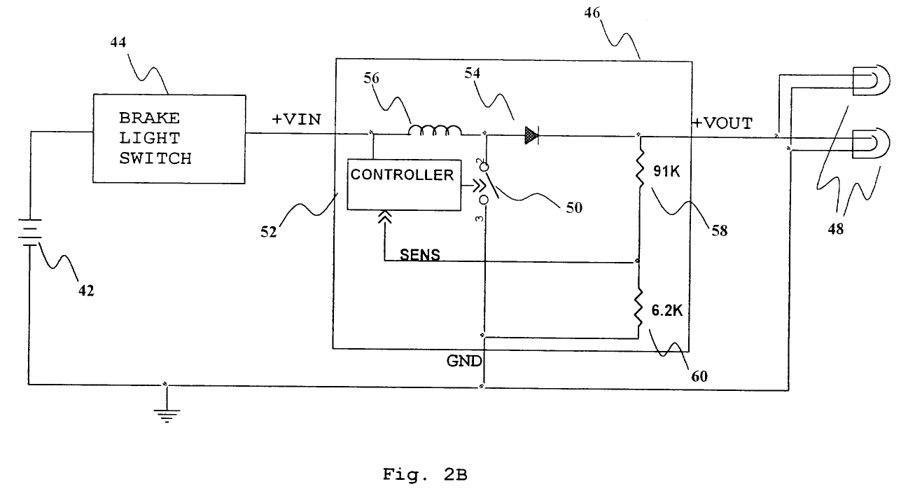

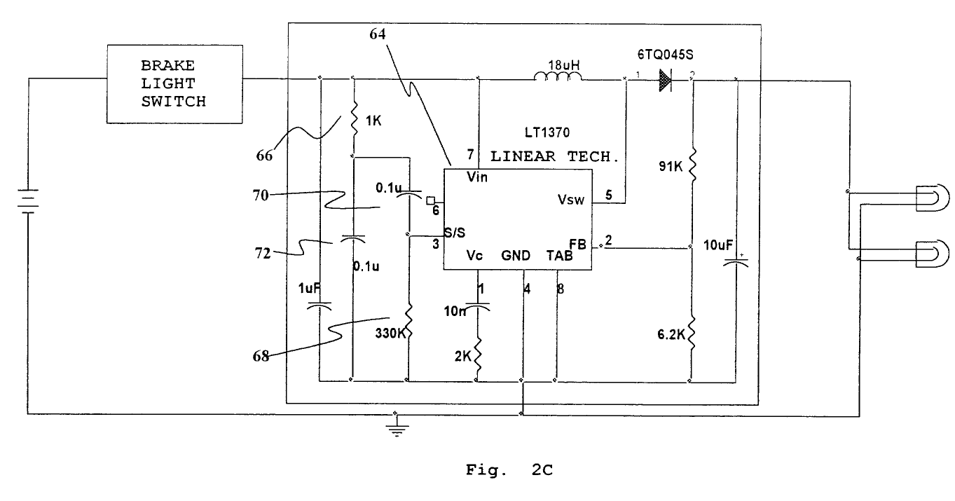

Reference is now made to FIG. 2A, which is a simplified timing diagram illustrating operation of a brake light system constructed and operative in accordance with a preferred embodiment of the present invention. Dashed lines indicate the operation of prior art systems while solid lines indicate the operation of the system of the present invention Plots of luminance, current and voltage appear and are distinguished by their line thickness.

As seen in FIG. 2A, typically, in the prior art it takes about 200 msec from actuation of a brake light switch for a brake light to become sufficiently illuminated so as to be noticed by a following driver As also seen in FIG. 2A, in a preferred embodiment of the present invention, the typical time of about 200 msec from actuation of a brake light switch for a brake light to become sufficiently illuminated so as to be noticed by a following driver is here reduced to about 70 msecs, thus enabling significantly earlier reaction on the part of a following driver

It is a particular feature of this preferred embodiment of the present invention that notwithstanding substantial and significant reduction in the time required for illumination of the brake light, the inrush current to the brake lights is reduced, by approximately one third below its typical value. Thus, in accordance with this embodiment of the invention, two seemingly contradictory advantages are achieved, significantly speedier illumination of the brake light and significantly lower inrush current resulting in significantly greater brake light lifetime

These two advantages are achieved in accordance with a preferred embodiment of the present invention by briefly boosting the voltage applied to the brake light, and also limiting the current applied to the brake light. This boosting is indicated at reference numeral 36

It is a particular feature of the present invention that boosting the voltage as indicated, with a short delay after the onset of illumination, does not appreciably change the inrush current supplied to the brake lights, notwithstanding that it does affect the current downstream from the inrush current peak. It is appreciated that the inrush current peak significantly affects brake light lifetime, as well as other electrical parameters of the circuitry, such as required wire diameter and noise

Reference is now made to FIG. 2B, which is a simplified block diagram illustration of circuitry employed in the brake light system whose operation is illustrated in FIG. 2A. As seen in FIG. 2B, a series connection is defined between a vehicle battery 42, a brake light switch 44 coupled to a brake lever of a vehicle, a current control circuit 46 and brake lights 48 The current control circuit 46 preferably comprises an electronic switch 50, the operation of which is governed by a controller 52. Electronic switch 50 governs a switching power supply including a diode 54 and an inductor 56. A pair of series connected resistors 58 and 60, preferably having the values indicated in FIG. 2B, is provided between the voltage output of diode 54 and ground The voltage at the junction between resistors 58 and 60 is fed back to controller 52 to enable controller 52 to control the output voltage supplied to the brake lights 48

It is noted that a change in the value of resistor 58 as compared with the value of resistor 28 (FIG. 1B) and a change in the controller 52 as will be apparent hereinbelow from a consideration of FIG. 2C, provide the required voltage boost at the appropriate time interval

Reference is now made to FIG. 2C, which is a simplified, self-explanatory, electrical schematic illustration of the circuitry of FIG. 2B. It is noted that the electronic switch 50 and the controller 52 are both principally embodied in a single integrated circuit 64, preferably a Linear Technologies LT1370. It is a particular feature of the present invention that timing circuitry, here comprising resistors 66 and 68 and capacitors 70 and 72, determines the time interval during which voltage is boosted Reference is made to applicant's Published PCT Patent Application WO 02/28667, the disclosure of which is hereby incorporated by reference.

It will be appreciated by persons skilled in the art that the present invention is not limited by what has been particularly shown and described hereinabove Rather the scope of the present invention includes both combinations and subcombinations of the various features described hereinabove as well as variations and modifications which would occur to persons skilled in the art upon reading the specification and which are not in the prior art.

1 A brake light system for a land motor vehicle comprising
a source of electrical power adapted to be mounted in a land motor vehicle,
at least one brake light;
a brake light switch connecting said at least one brake light to said source of electrical power, and
a voltage booster for increasing the voltage of said electric power received from said source of electrical power to a higher voltage which is supplied to said at least one brake light

2 A brake light system for a land motor vehicle according to claim 1 and wherein said voltage booster includes a voltage boosting timing functionality operative to provide voltage boosting by said voltage booster only after occurrence of an inrush current peak in the electrical power which is supplied to said at least one brake light

3 A brake light system according to claim 1 and wherein said voltage booster comprises current attenuating functionality operative to attenuate the peak inrush current supplied to said at least one brake light.

4. A brake light system according to claim 2 and wherein said voltage booster comprises current attenuating functionality operative to attenuate the peak inrush current supplied to said at least one brake light

5 A brake light system according to claim 1 and wherein said voltage booster is also operative for initially illuminating said at least one brake light to a relatively high level of illumination and thereafter to reduce illumination of said at least one brake light to a relatively low level of illumination.

6 A brake light system according to claim 2 and wherein said voltage booster is also operative for initially illuminating said at least one brake light to a relatively high level of illumination and thereafter to reduce illumination of said at least one brake light to a relatively low level of illumination.

7 A brake light system according to claim 3 and wherein said voltage booster is also operative for initially illuminating said at least one brake light to a relatively high level of illumination and thereafter to reduce illumination of said at least one brake light to a relatively low level of illumination

8 A brake light system according to claim 4 and wherein said voltage booster is also operative for initially illuminating said at least one brake light to a relatively high level of illumination and thereafter to reduce illumination of said at least one brake light to a relatively low level of illumination.

9 A brake light operating method for a land motor vehicle comprising a source of electrical power, at least one brake light and a brake light switch connecting said at least one brake light to said source of electrical power, the method comprising:
increasing the voltage of said electric power received from said source of electrical power to a higher voltage; and
supplying electrical power at said higher voltage to said at least one brake light

10 A brake light operating method for a land motor vehicle according to claim 9 and wherein said increasing the voltage occurs after occurrence of an inrush current peak in the electrical power supplied to said at least one brake light.

11 A brake light operating method according to claim 9 and also comprising attenuating the inrush current peak supplied to said at least one brake light.

12 A brake light operating method according to claim 10 and also comprising attenuating the inrush current peak supplied to said at least one brake light.

13. A brake light operating method according to claim 9 and also comprising initially illuminating said at least one brake light to a relatively high level of illumination and thereafter reducing illumination of said at least one brake light to a relatively low level of illumination.

14 A brake light operating method according to claim 10 and also comprising initially illuminating said at least one brake light to a relatively high level of illumination and thereafter reducing illumination of said at least one brake light to a relatively low level of illumination

15 A brake light operating method according to claim 11 and also comprising initially illuminating said at least one brake light to a relatively high level of illumination and thereafter reducing illumination of said at least one brake light to a relatively low level of illumination

16 A brake light operating method according to claim 12 and also comprising initially illuminating said at least one brake light to a relatively high level of illumination and thereafter reducing illumination of said at least one brake light to a relatively low level of illumination
